(19) United States
(12) Patent Application Publication
(10) Pub. No.: US 2021/0211095 A1
(43) Pub. Date: Jul. 8, 2021

(54) Reliability Test Device for Flexible Photovoltaic Module

(71) Applicant: MiaSole Equipment Integration (Fujian) Co., Ltd., Quanzhou, Fujian (CH)

(72) Inventors: Yongyuan XU, Quanzhou, Fujian (CN); Pengchen HU, Quanzhou, Fujian (CN); Shan YI, Quanzhou, Fujian (CN); Jihong XIAO, Quanzhou, Fujian (CN); Xianyi HUANG, Quanzhou, Fujian (CN); Erfeng PAN, Quanzhou, Fujian (CN); Wenjun MA, Quanzhou, Fujian (CN); Libing LIU, Quanzhou, Fujian (CN)

(21) Appl. No.: 16/075,581

(22) PCT Filed: Jul. 5, 2018
(86) PCT No.: PCT/CN2018/094698

§ 371 Date: Aug. 3, 2018

(30) Foreign Application Priority Data
Nov. 1, 2017 (CN) 201721439727.5

(51) Int. Cl. H02S 50/10

(52) U.S. Cl. CPC H02S 50/10; H02S 30/20

(57) ABSTRACT

The present disclosure discloses a reliability test device for flexible photovoltaic module, this reliability test device for flexible photovoltaic module comprises: an environment test box, a temperature acquisition means and a placing rack placed inside an environment test box; the placing rack comprises at least one set of oppositely provided vertical frames, and a plurality of carriers horizontally stacked between the vertical frames, the carriers and the vertical frames are fixedly connected; a first gap is provided between the carriers, and a plurality of gas holes are provided on the carriers; the flexible photovoltaic module is horizontally placed on the carrier, and the temperature acquisition means is fixedly provided on a surface of the flexible photovoltaic module. In the present disclosure, problems of undesirable structures such as deformation and creeping of the module caused by vertically placing the module are eliminated, meanwhile in preferred solutions, by providing a baffle, the gas circulation flow direction in the test box is changed, such that the module maintains a uniform temperature and a uniform humidity during heating up and cooling down, and accordingly accurate and effective reliability evaluation results can be obtained.

### CROSS-REFERENCE TO RELATED APPLICATION(S)

This application is a 371 U.S. National Phase of International application No. PCT/CN2018/094698, filed Jul. 5, 2018, and claims benefit/priority of Chinese patent application No. 2017-21439727.5, filed Nov. 1, 2017, the contents of all of which are incorporated herein by reference in entirety.

### TECHNICAL FIELD

The present disclosure relates to the field of flexible photovoltaic module test, and particularly to a reliability test device for flexible photovoltaic module.

### BACKGROUND ART

Currently, among numerous products of module types, flexible photovoltaic module is gradually becoming a future trend of photovoltaic module as it is bendable and has a light weight, having a quite wide range of application prospect, therefore, a reliability test of the flexible photovoltaic modules is rather important. The so-called reliability test generally refers to a tolerance test regarding to the environment, for example, an assessment of the structure and performance of the modules in a-humidity-heating, thermocycling or humidity-freezing environmental conditions and the like.

Conventional reliability test devices are regarding to rigid modules such as double-glass modules or single-glass modules, since the front panel and the back panel of the flexible photovoltaic module are both flexible materials, bending and deformation effects will inevitably occur due to the effect of gravity as the flexible photovoltaic module is placed vertically in a chamber of a test box, thus causing the film layer of the battery to be damaged by non-environment factors, meanwhile, changes such as high-low temperature circulation inside the test box will cause intenerating of materials of respective layers of the flexible module, and aggravate the deformation of the module and damage to the film layer of the battery, therefore, the conventional reliability test devices cannot precisely assess reliability performances of the flexible modules.

### SUMMARY

Objects of the present disclosure at least include, providing a reliability test device for flexible photovoltaic module, such that irregular deformation and creeping effects will not occur to the flexible photovoltaic module, and the reliability test results of the module are ensured to be accurate and effective.

The technical solution used in the present disclosure is as follows:

A reliability test device for flexible photovoltaic module, includes:

an environment test box, a temperature acquisition means and a placing rack placed inside the environment test box;

the placing rack includes at least one set of oppositely provided vertical frames, and a plurality of carriers horizontally stacked between the vertical frames, the carriers and the vertical frames are fixedly connected;

a first gap is provided between the carriers, and a plurality of gas holes are provided on the carriers;

a flexible photovoltaic module is horizontally placed on the carriers, and the temperature acquisition means is fixedly provided on a surface of the flexible photovoltaic module.

Optionally, the reliability test device further includes: a baffle configured to guide the flow of a test gas, the baffle is horizontally provided on the carriers of the uppermost layer.

Optionally, a second gap is provided between the vertical frames and an inner wall of the environment test box.

Optionally, a gas vent is provided on the bottom portion of the environment test box.

Optionally, the temperature acquisition means is a thermocouple, and the thermocouple is bonded on a surface of the flexible photovoltaic module.

Optionally, the reliability test device further includes, a humidity sensor, the humidity sensor is fixedly provided inside the environment test box, and the humidity sensor is configured to monitor the humidity inside the environment test box.

Optionally, a threading hole is further provided on the environment test box, and the threading hole is configured to thread the leads of the thermocouple and/or the humidity sensor.

Optionally, the environment test box is any one of the followings: a humidity-heating test box, a thermocycling test box or a humidity-freezing test box.

Optionally, the carriers have a grid-shape structure.

Optionally, the material of the placing rack is an anti-corrosion rigid material.

Optionally, the vertical frames have a non-closed structure.

Optionally, the vertical frames have a column shape.

Optionally, a plurality of the carriers are provided at equal intervals along the vertical direction.

Optionally, the vertical frames are provided with guide rails, the guide rails are horizontally placed, the carriers slide fit the guide rails and the carriers can slide along the guide rails.

Optionally, at least one carrier is provided with a plurality of flexible photovoltaic modules, and a gap is kept between the adjacent flexible photovoltaic modules on the same carrier.

In the present disclosure, regarding to the reliability test of the flexible photovoltaic module, by means of a structure of the placing rack and the carriers thereof, the flexible photovoltaic module is so that more reasonably placed horizontally in the environment test box, thus eliminating effects such as deformation and creeping of the module and damages to the module structure caused by vertically placing the module, meanwhile in the preferred solutions, by providing the baffle, the gas circulation flow direction in the test box is changed, such that the module keeps a uniform temperature and a uniform humidity during heating up and cooling down, and accordingly accurate and effective reliability assessment results can be obtained.

### BRIEF DESCRIPTION OF THE DRAWINGS

In order to make the objects, technical solutions and advantages of the present disclosure more clear, the present disclosure will be further described below in combination with figures.

FIG. 1 is a schematic view of a reliability test device for flexible photovoltaic module provided in an embodiment of the present disclosure;

FIG. 2 is a top view of FIG. 1;

FIG. 3 is a schematic view of a reliability test device for flexible photovoltaic module provided in another embodiment of the present disclosure;

FIG. 4 is a right view of an environment test box in FIG. 3;

FIG. 5 is a schematic view of a reliability test device for flexible photovoltaic module provided in another embodiment of the present disclosure;

FIG. 6 is a structural schematic view of a baffle provided in another embodiment of the present disclosure;

FIG. 7 is a structural schematic view of a placing rack provided in another embodiment of the present disclosure;

FIG. 8 is an enlarged view of a place A in FIG. 7;

FIG. 9 is a structural schematic view of a placing rack provided in another embodiment of the present disclosure.

### REFERENCE SIGNS

1 environment test box, 11 threading hole, 12 gas vent, 2 placing rack, 201 carrier, 2011 gas hole, 202 vertical frame, 3 flexible photovoltaic module, 4 baffle, 401 flow-guiding hole, 5 guide rail, 6 temperature acquisition means, 7 humidity sensor, 8 lead, 9 computer.

### DETAILED DESCRIPTION OF THE PREFERRED EMBODIMENT

Embodiments of the present disclosure are described in detail below, and examples of the embodiments are shown in the figures, in which like or similar signs represent like or similar elements or elements having like or similar functions throughout the figures. The embodiments described below with reference to the figures are exemplary, and merely used to explain the present disclosure, but cannot be construed as limitation to the present disclosure.

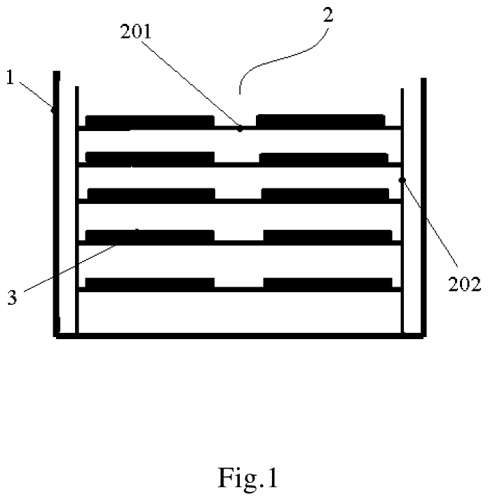

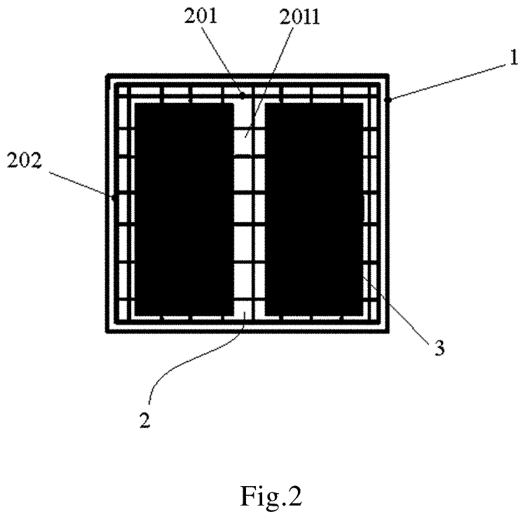

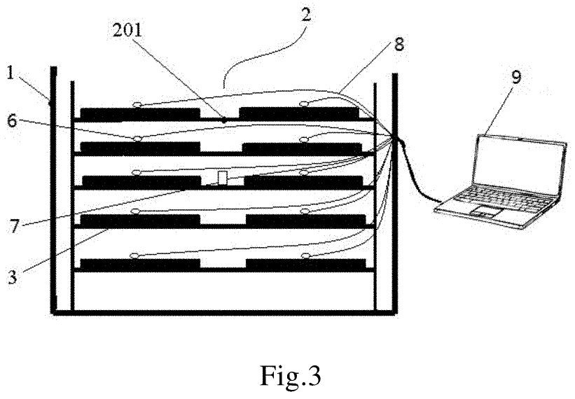

An embodiment of the present disclosure provides a reliability test device for flexible photovoltaic module, as shown in FIG. 1, FIG. 2 and FIG. 3, including:

an environment test box 1, a temperature acquisition means 6 (as shown in FIG. 3) and a placing rack 2 placed inside the environment test box 1, in practical operations, the environment test box 1 can be any one of test box in a reliability test of modules, for example, a humidity-heating test box, a thermocycling test box or a humidity-freezing test box.

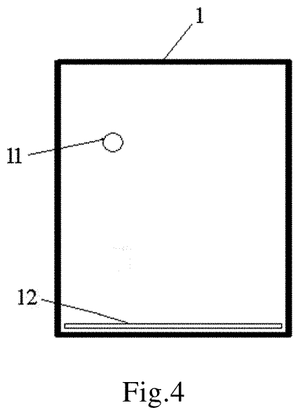

In the above, structures of the placing rack 2 can include at least one set of oppositely provided vertical frames 202 and a plurality of carriers 201 horizontally stacked between the vertical frames 202 provided in the set, “stacked” herein does not refer to “stack on one another”, but a first gap is further provided between each of the respective carriers 201, which gaps are configured for operations such as taking and placing the flexible photovoltaic modules 3, moreover, the vertical frames 2 are in a non-closed structure, thus it is ensured that the test gas can sufficiently and uniformly flow through side faces of the placing rack 2, for example, the test gas can be rebounded by an inner wall of the environment test box 1, then flow into the placing rack 2 from the vertical frame 202; it also needs to be indicated herein that when the number of the vertical frames 202 provided in set mentioned in the preceding is one pair, the module can be placed or taken through two faces where the vertical frame 202 is not provided, when the number of the vertical frames 202 provided in set mentioned in the preceding is two pairs, that is, four vertical frames 202 peripherally form four side faces of the placing rack 2, as shown in FIG. 2, then it can be considered that relatively big gaps are provided on the vertical frames 202, that is, adjacent carriers 201 are provided with a relatively big gap on the vertical frames 201, such that operations of taking and placing the module from and on the carrier 201 are convenient; the number of the vertical frames 202 also can be three, for example, the vertical frame 202 is a vertical board in a grid shape, three such vertical frames 202 peripherally form three side faces of the placing rack 2, and the module can be placed or taken through one face where the vertical frame 202 is not provided thereon. Besides, the carriers 201 can be connected to the vertical frames 202 in a manner such as welding, and also can be connected in a detachable connecting manner, for example, clamping and snapping. It also needs to be indicated herein that using the structure of vertical frames 202 in the present disclosure aims at ensuring the overall stability of the placing rack 2, and of course, in other embodiments, four corners of the placing rack 2 can be respectively provided with four vertical columns to replace the vertical frames, four corners of the carrier 201 are in fixed connection with the four vertical columns respectively, then a structure of the placing rack 2 also can be constructed; furthermore, a plurality of gas holes 2011 are further provided on the carriers 201, which gas holes 2011 are configured for the test gas to flow there through from top to bottom, and which gas holes 2011 can be a plurality of circular through holes, in one preferred solution of the present disclosure, the carriers 201 use a grid-shape structure as shown in FIG. 2, then the gas holes 2011 mentioned in the preceding can be in a square shape; when the present test device is used, the flexible photovoltaic module 3 is horizontally placed on the carrier 201, the temperature acquisition means 6 mentioned in the preceding is fixedly provided on a surface of the flexible photovoltaic module 3, and in practical operations, the temperature acquisition means 6 can be a conventional temperature sensor such as a thermocouple, and the thermocouple can be bonded on the surface of the flexible photovoltaic module 3. The thermocouple can be bonded on the surface of the flexible photovoltaic module 3 by means of a high-temperature resistant and humidity-resistant adhesive tape. In another preferred solution of the present disclosure, one or more humidity sensors 7 also can be fixedly provided inside the environment test box 1, the function of which is monitoring the humidity inside the environment test box. Of course, furthermore, as shown in FIG. 3 and FIG. 4, one or more threading holes 11 can also be further provided on the environment test box 1, which threading hole 11 is configured to thread the leads 8 of the thermocouple and/or the humidity sensor 7 mentioned in the preceding. The thermocouple and/or the humidity sensor 7 mentioned in the preceding is connected to a computer 9 through the lead 8. The threading hole 11 is sealed thereat with a soft material with a relatively good sealing performance, ensuring the sealing performance at the threading hole 11.

It also needs to explain for the above embodiment that when the placing rack 2 is placed into the environment test box 1, a second gap can be formed between the placing rack 2 and the inner wall of the environment test box 1, that is, there is a certain gap provided from the vertical frames 202 to the inner wall of the environment test box 1, for example, the second gap can be of 100 mm, thus the test gas can flow well inside the environment test box 1; moreover, as shown in the FIG. 1, when the flexible photovoltaic module 3 is placed flatwise, a gap with enough clearance can be kept between the modules, which is also favorable to the gas flow in a test course.

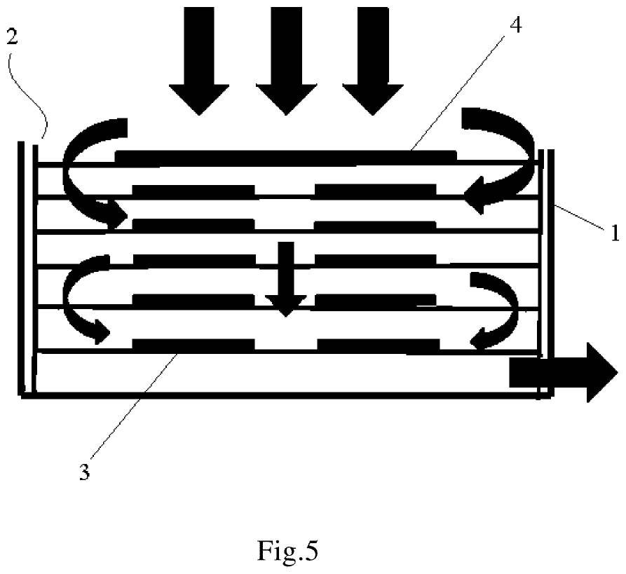

Taking the through flow of the test gas into consideration, in another embodiment of the present disclosure, as shown in FIG. 5, a baffle 4 configured to guide the flow of the test gas is further included, the baffle 4 can be horizontally placed on the carrier 201 of the uppermost layer of the placing rack 2, and then the flexible photovoltaic modules 3 are placed on the carriers 201 of other layers, more preferably, gas vents 12 (see FIG. 4) further can be provided on the bottom portion of the environment test box 1 and the bottom portion of the placing rack 2, thus the flow path of the gas flow can be changed from the original vertically downward flow to a placing manner more suitable to the flexible photovoltaic modules 3 provided in the present disclosure (referring to arrows shown in FIG. 5 for a gas flow direction), accordingly, the temperature and humidity of various modules inside the environment test box will satisfy the test requirements.

The baffle 4 is provided on the carrier 201 of the placing rack 2, and the baffle 4 can be horizontally placed on the carrier 201, and also can be obliquely placed on the carrier 201, as long as it can be functional in guiding the flow of the test gas. Preferably, referring to FIG. 5, the baffle 4 is horizontally placed on the carrier 201, to facilitate the test gas to flow above from the baffle 4 uniformly to two sides of the baffle 4.

In the present embodiment, the baffle 4 can be placed on the carrier 201 of the uppermost layer of the placing rack 2, and the flexible photovoltaic modules 3 are then placed on the other respective layers of the carriers 201.

The baffle 4 can have various suitable shapes, for example, flat plate shape, bent plate shape, semicircular shape and the like. Preferably, as shown in FIG. 5, the baffle 4 has a flat plate shape, and compared with baffles of other shapes, the baffle 4 with a flat plate shape itself has a relatively small volume, and the baffle with a flat plate shape can tightly fit the carrier 201, and occupy a relatively small space inside the environment test box 1.

A region covered by the baffle 4 is compatible to the cross section area of an air vent, and when the air vent is relatively large, preferably, the baffle 4 covers a portion of the carrier 201 provided with the flexible photovoltaic module 3 (see FIG. 5), and with the shielding of the baffle 4, the flexible photovoltaic module is prevented from directly contacting the high-velocity test gas at the air vent, such that the test environment where all the flexible photovoltaic modules are located is uniform, that is, the flexible photovoltaic modules maintain uniform temperature and humidity during heating up and cooling down, such that the accurate and effective test results can be obtained.

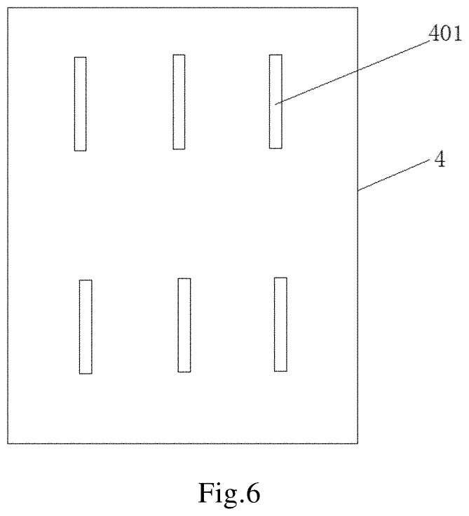

Referring to FIG. 6, when there are relatively more flexible photovoltaic modules on the carriers 201 of each layer, a plurality of flow-guiding holes 401 can be provided on the baffle 4, thus a part of the test gas entering into the environment test box 1 from above, after contacting the baffle, flows to two sides, and another part of the test gas flows downwards through the flow-guiding holes 401 on the baffle 4, such that the gas inside the environment test box 1 flows uniformly.

There may be one baffle 4 or several. When there are relatively more flexible photovoltaic modules on each layer of the carrier 201, a plurality of baffles 4 also can be at Intervals provided on the uppermost layer of the carrier 201, with gaps being kept between adjacent baffles 4.

Finally, it also can be additionally explained that rigid materials that have high-temperature resistance, moisture-corrosion resistance, advantages of air circulation and certain carrying capability can be used as a material of the placing rack 2. In the present embodiment, the placing rack 2 uses an alloy material, for example, stainless steel material, aluminum alloy and titanium alloy.

The present disclosure provides a reliability test device for flexible photovoltaic module, which reliability test device includes: an environment test box 1 and a placing rack 2 placed inside the environment test box 1; the placing rack 2 includes at least one carrier 201 horizontally provided, and the carrier 201 is configured to support a flexible photovoltaic module 3.

In the above, the placing rack 2 can have various suitable shapes such as circular shape, triangular shape, quadrilateral shape, pentagonal shape, and hexagonal shape. Generally, the placing rack 2 has a shape adapted to a shape of the environment test box 2, such that an edge of the placing rack 2 maintains a uniform distance from an inner wall of the environment test box 1, facilitating sufficient and uniform flow of the test gas. In the embodiment shown in FIG. 2, the placing rack 2 has a rectangular shape, and the environment test box 2 has a rectangular shape.

In the above, the carrier 201 can be directly connected to the inner wall of the environment test box 1, for example, the carrier 201 is plugged, bonded, clamped to the inner wall of the environment test box 1.

Preferably, the placing rack 2 further includes a vertical frame 202, the carrier 201 is connected to the vertical frame 202, and the carrier 201 is configured to support the vertical frame 202. The carrier 201 and the vertical frame 202 are connected, together to form in one piece, such that the overall placing rack 2 can be taken out from or placed into the environment test box 1, that is, facilitating placing the flexible photovoltaic module 3, and meanwhile also facilitating cleaning the placing rack 2.

As shown in FIG. 1 to FIG. 3 and FIG. 5, the placing rack 2 is center provided in the environment test box 1, that is to say, two sides of the placing rack 2 have the equal distances from the inner wall of the environment test box 1. Meanwhile, the baffle 4 is also center provided in the carrier 201, thus it can ensure that when the test gas inside the environment test box 1 flows downwards above from the baffle 4 along the arrows shown in FIG. 5, the gas at two sides of the placing rack 2 have the equal flow velocity, and the test gas at the two sides flows uniformly.

Optionally, the vertical frame 202 has a closed structure, now, the carrier 201 can be provided with a drawer structure, that is, the carrier 202 can slide in the horizontal plane with respect to the vertical frame 202, so as to take and place the flexible photovoltaic module 3. Preferably, the vertical frame 202 has a non-closed structure, facilitating directly taking and placing the flexible photovoltaic module, and facilitating the test gas to enter the inside of the placing rack 2 through the non-closed portion of the vertical frame 202.

Optionally, the vertical frame 202 has a plate shape, the vertical frame 202 having a plate shape is provided with a plurality of gas holes, and the gas entering above from the environment test box 1, after contacting the inner wall of the environment test box 1 and being rebounded by the inner wall of the environment test box 1, enters into the placing rack 2 through the gas holes on the vertical frame 202.

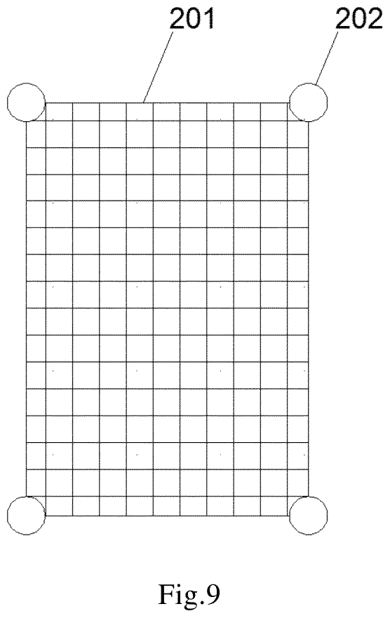

Preferably, the vertical frame 202 has a column shape, and referring to FIG. 9, a plurality of vertical frame 202 having a column shape are provided at intervals to support the carrier 201 together. The vertical frames 202 having a column shape used in the present embodiment can ensure the overall stability of the placing rack 2, and since there is a play with enough space between the two adjacent vertical frames 202, not only the module can be conveniently taken out or placed into through this play, but also meanwhile the test gas conveniently enters into the placing rack through this play, such that the test gas flows more smoothly.

As shown in FIG. 2, the carrier 201 has a grid shape structure, that is to say, apart from borders, the carrier 201 further has a grid shape structure inside, and the grid shape structure not only can support the flexible photovoltaic module and prevent the middle portion of the flexible photovoltaic module from deforming, but also meanwhile has a plurality of gas holes 2011, through which gas holes 2011 the test gas can be in full and uniform contact with the flexible photovoltaic module.

Preferably, grids on the carrier 201 are uniform and consistent, facilitating the test gas to flow uniformly inside the placing rack.

There may be one carrier 201 or several, and preferably, the carrier 201 is in plurality, and a plurality of carriers 201 are provided at intervals along the vertical direction, such that more flexible photovoltaic modules can be placed. As shown in FIG. 1, there are five layers of the carrier 1 in total, and at least two flexible photovoltaic modules are placed on each layer of the carrier 201. As shown in FIG. 5, there are six layers of the carrier 1 in total, the baffle 4 is placed on the uppermost layer of the carrier 201, and at least two flexible photovoltaic modules are placed on each of the other layer of the carrier 201.

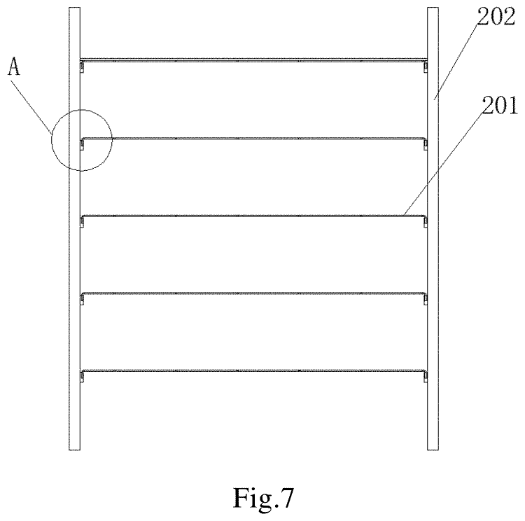

Optionally, referring to FIG. 1 and FIG. 7, a plurality of carriers 201 are provided at equal intervals, which not only facilitates taking and placing the module from and onto the carrier 201, but also meanwhile facilitates the machining of the placing rack.

The test gas can enter from the top portion of the environment test box, and be discharged from the bottom portion, that is, a gas inlet is provided on the top portion of the environment test box, and a gas outlet is provided on the bottom portion of the environment test box. The test gas also can enter from the bottom portion of the environment test box, and be discharged from the top portion, that is, a gas inlet is provided on the bottom portion of the environment test box, and a gas outlet is provided on the top portion of the environment test box.

When the test is implemented in a thermocycling environment condition, the test gas can enter from the top portion of the environment test box, and be discharged from the bottom portion; the test gas also can enter from the bottom portion of the environment test box, and be discharged from the top portion.

When the test is implemented in a humidity-heating or a humidity-freezing environment condition and the like, preferably, the test gas can enter from the top portion of the environment test box, and be discharged from the bottom portion of the environment test box. In this way, the test gas with a certain humidity, after the moisture condensation therein, can flow out from this environment test box under gravity.

That is to say, when the gas inlet is provided on the top portion of the environment test box, and the gas outlet is provided on the bottom portion of the environment test box, not only the test in the thermocycling environment condition can be well implemented, but also the test in the humidity-heating and the humidity-freezing environment conditions and the like can be implemented.

As shown in FIG. 5, when the test gas flows from top to bottom, a flow velocity of the test gas becomes less as the test gas flows downward, and in order to enable a plurality of flexible photovoltaic modules to be located in a uniform and consistent test environment, optionally, from top to bottom, intervals between the adjacent carriers 201 are gradually increased.

Besides, as shown in FIG. 1, the wall thickness of the environment test box 1 is greater than the wall thickness of the vertical frame 202.

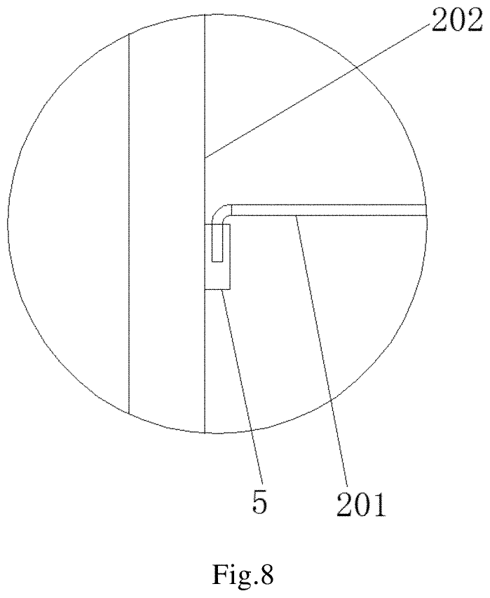

In order to realize adjustment of the position of the carrier 201 in a horizontal direction, and conveniently take out and place into the flexible photovoltaic module, optionally, the carrier 201 is provided with a drawer structure, specifically, referring to FIG. 7 and FIG. 8, guide rails 5 are provided on the vertical frame 202, the guide rails 5 are horizontally placed, two sides of the carrier 201 slide fit the guide rails 5, and the carrier 201 can slide along the guide rails 5. The flexible photovoltaic module can be taken out or placed into by pulling the carrier 201 outward from the vertical frame 202.

At least one of the carriers is thereon provided with a plurality of flexible photovoltaic modules, and a gap is kept between the adjacent flexible photovoltaic modules on the same carrier, such that the test gas flows smoothly.

To sum up, occurrence of bending and deformation of the module due to gravity when the test is implemented in the vertical direction is avoided in the present disclosure, accordingly it is more adaptable to the reliability test of the flexible photovoltaic module, and improvingly simulates real outdoor operation situations of the flexible photovoltaic module; moreover, by providing the baffle, the original gas circulation flow direction in the test box is changed, such that the module maintains a uniform temperature and a uniform humidity during heating up and cooling down, and accordingly accurate and effective test results can be obtained.

The configuration, features and effects of the present disclosure are described in detail in the above according to the embodiments shown in the figures, while the above-mentioned are merely for preferred embodiments of the present disclosure, and it should be indicated that a person skilled in the art can reasonably combine the technical features involved in the above embodiments and other preferred embodiments into a plurality of equivalent solutions, without departing from or changing the design idea and technical effects of the present disclosure; therefore, an implementation scope of the present disclosure is not limited to that shown in the figures, but all alterations or modifications made according to the concept of the present disclosure are equivalent embodiment of equal changes, and all should fall within the scope of protection of the present disclosure when they still do not go beyond the spirit covered by the description and figures.

1. A reliability test device for flexible photovoltaic module, comprising:
an environment test box, a temperature acquisition means and a placing rack placed inside the environment test box,
wherein the placing rack comprises at least one set of oppositely provided vertical frames, and a plurality of carriers horizontally stacked between the vertical frames, the carriers and the vertical frames are fixedly connected;
a first gap is provided between the carriers, and a plurality of gas holes are provided on the carriers; and
a flexible photovoltaic module is horizontally placed on the carrier, and the temperature acquisition means is fixedly provided on a surface of the flexible photovoltaic module.

2. The reliability test device of claim 1, further comprising a baffle configured to guide flow of a test gas, wherein the baffle is horizontally provided on the carriers of the uppermost layer.

3. The reliability test device of claim 2, wherein a second gap is provided between the vertical frames and an inner wall of the environment test box.

4. The reliability test device of claim 2, wherein a gas vent is provided on a bottom portion of the environment test box.

5. The reliability test device of claim 2, wherein the temperature acquisition means is a thermocouple, and the thermocouple is bonded on a surface of the flexible photovoltaic module.

6. The reliability test device of claim 1, further comprising a humidity sensor, wherein the humidity sensor is fixedly provided inside the environment test box, and the humidity sensor is configured to monitor humidity inside the environment test box.

7. The reliability test device of claim 1, wherein a threading hole is further provided on the environment test box, and the threading hole is configured to thread leads of a thermocouple and/or a humidity sensor.

8. The reliability test device of claim 1, wherein the environment test box is any one of: a humidity-heating test box, a thermocycling test box and a humidity-freezing test box.

9. The reliability test device of claim 1, wherein the carriers have a grid-shape structure.

10. The reliability test device of claim 1, wherein material of the placing rack is an anti-corrosion rigid material.

11. The reliability test device of claim 1, wherein the vertical frames have a non-closed structure.

12. The reliability test device of claim 1, wherein the vertical frames are in a column shape.

13. The reliability test device of claim 1, wherein a plurality of carriers are provided at equal intervals along a vertical direction.

14. The reliability test device of claim 1, wherein the vertical frames are provided with guide rails, the guide rails are horizontally placed, the carriers are in sliding fit with the guide rails and the carriers are slidable along the guide rails.

15. The reliability test device of claim 1, wherein at least one of the carriers is provided thereon with a plurality of flexible photovoltaic modules, and a gap is formed between the adjacent flexible photovoltaic modules on the same carrier.

16. The reliability test device of claim 3, wherein the temperature acquisition means is a thermocouple, and the thermocouple is bonded on a surface of the flexible photovoltaic module.

17. The reliability test device of claim 2, wherein a threading hole is further provided on the environment test box, and the threading hole is configured to thread leads of a thermocouple and/or a humidity sensor.

18. The reliability test device of claim 2, wherein the environment test box is any one of: a humidity-heating test box, a thermocycling test box and a humidity-freezing test box.

19. The reliability test device of claim 2, wherein the vertical frames are provided with guide rails, the guide rails are horizontally placed, the carriers are in sliding fit with the guide rails and the carriers are slidable along the guide rails.

20. The reliability test device of claim 2, wherein at least one of the carriers is provided thereon with a plurality of flexible photovoltaic modules, and a gap is formed between the adjacent flexible photovoltaic modules on the same carrier.
